(19) United States
(12) Patent Application Publication
(10) Pub. No.: US 2006/0157991 A1
(43) Pub. Date: Jul. 20, 2006

(54) Adjustable door strike plate assembly

(76) Inventor: Tam Nguyen, Alberta (CA)

Correspondence Address: DINSMORE & SHOHL, LLP, 1900 CHEMED CENTER, 255 EAST FIFTH STREET, CINCINNATI, OH, 45202, US

(21) Appl. No.: 11/097,915

(22) Filed: Apr. 1, 2005

(30) Foreign Application Priority Data
Jan. 19, 2005 (CA) 2493151

(51) Int. Cl. E05B 15/02

(52) U.S. Cl. 292/341.18

(57) ABSTRACT

The present invention is an adjustable strike plate assembly for a doorjamb that includes a first portion defining a rectangular opening for receiving a deadbolt and a second portion that is mounted between the first portion and the doorjamb to define one edge of the rectangular opening. The second portion is adjustable in the adjustment direction that is at right angles to the side edge of the opening. The second portion comprises elongated horizontal openings having teeth on the upper and lower edges of the openings. Protruding from the abutting surface of the first portion are keys or gears adapted to engage the teeth of the elongated openings. The second portion's position is secured in relation to the first portion when the teeth of the elongated openings engage the gears protruding from the first portion.

### FIELD OF THE INVENTION

The present invention relates to the field of door strike plate assemblies for doorjambs, specifically, assemblies having an adjustable strike plate portion that interlocks with a fixed strike plate portion.

### BACKGROUND OF THE INVENTION

It is known to provide a strike plate assembly mounted on a doorjamb which includes a first strike plate portion having a plurality of first openings for each for receiving a screw passing therethrough for fastening a strike plate to the door jamb. The first strike plate portion generally includes a rectangular opening for receiving the bolt of a door lock through the opening. In order to adjust the vertical edge of the opening in the direction parallel to the movement of the door, the vertical edge is provided on a second strike plate portion that can move in the direction of movement to the door which is perpendicular to the vertical edge. This adjustment is used to vary the position of the bolt relative to the doorjamb when the door is in the closed position to accommodate warping in the door that can occur due to temperature changes and to moisture changes.

One commercially available device is shown in U.S. Pat. No. 4,171,836 issued to St. Aubin. In this device, the second plate portion is mounted between the first plate portion and the jamb and is, therefor, squeezed between the underside of the first plate portion and the jamb by attachment screws that pass through openings in the first plate portion and through elongate adjustment openings in the second plate portion. In order to attempt to prevent sliding of the second plate portion under the significant forces generated by the warping of a door, the underside of the first plate portion and the upper side of the second plate portion are serrated with grooves which are relatively narrow and spaced by relatively wide bands with those grooves extending perpendicular to the direction of movement of a door.

Another commercially available device is shown in Canadian patent No. 2,153,226 issued to Moon. In this device, the fixed plate portion has a plurality of horizontally spaced-apart vertical slots located above and below the bolt opening of the fixed portion. The movable second portion has vertically oriented protrusions that interlock with the corresponding slots on the fixed plate portion. As these protrusions are formed by a stamping process, they are semi-circular in shape and do not provide a large contact surface with the fixed plate portion when fitted into a slot.

In cold climate areas, where temperature changes can provide high warping forces on doors, the engagement between the first and second plate portions may be insufficient to prevent the second plate portion from being pushed relative to the doorjamb. It is, therefore, desirable to have an adjustable door strike plate assembly that is resistant to these warping forces.

### SUMMARY OF THE INVENTION

It is one object of the present invention to provide and improve an interlocking system for locating the second strike plate portion relative to the first strike plate portion of an adjustable door strike plate assembly.

According to one aspect of the present invention, there is provided an adjustable strike plate assembly for attachment to a doorjamb to engage the bolt of a door lock that comprises a fixed strike plate portion and a second movable strike plate portion. The fixed plate portion is a U-shaped member that slides onto the edge of a doorjamb. The fixed portion has an opening for receiving the bolt of a door lock. The second or adjustable plate portion of the present invention is placed between the fixed plate portion and the doorjamb. The second plate portion is capable of a horizontal movement relative to the fixed plate portion in the doorjamb. The second plate portion provides a vertical edge for the opening of the fixed plate portion to receive the bolt of the door lock. Openings in both the first and second plate portions permit the passing of a fastener therethrough into the doorjamb thereby fixing the adjustable door strike assembly in place.

Located between the abutting surfaces of the first and second strike plate portions are locating means. The locating means consist of elongated horizontal openings in the second strike plate portion that have serrations or teeth on the upper and lower edges of the openings. Protruding from the abutting surface of the first plate portion are keys or gears adapted to engage the teeth of the elongated openings of the second strike plate portion. Each gear has a cog, preferably an upper and lower cog capable of engaging the teeth of the elongated openings of the second strike plate portion. The position of the second strike plate portion relative to the first strike plate portion is dependent on which teeth the gear cogs have engaged. When fasteners are used to secure the strike plate assembly to a doorjamb, the second strike plate portion is tightly sandwiched between the doorjamb and the first strike plate portion. The interlocking action of the teeth on the second strike plate portion when engaged with the cogs of the gears on the first strike plate portion provide a positive interlocking of these two strike plate portions thereby preventing the movement of the second strike plate portion relative to the doorjamb.

Broadly stated, one aspect of the present invention is an adjustable strike plate assembly for attachment to a doorjamb to engage a bolt of a door lock, comprising: a first strike plate assembly portion having at least one first opening therein for receiving a fastener therethrough for fastening said first strike plate portion to said door jamb, and having a second opening for receiving said bolt; a second strike plate portion adapted for mounting between said first strike plate portion and said door jamb wherein said second strike portion comprises an abutting surface for contacting with an abutting surface of said first strike plate portion, said second strike plate portion further comprising a plate element thereof extending substantially vertical across said second opening thereby defining a vertical side edge of said second opening for engaging a vertical side of said bolt to hold said door in a closed position, said second strike plate portion further capable of movement relative to said first strike plate portion in an adjustment direction substantially perpendicular to said vertical side edge so as to vary the position the position of said vertical side edge relative to said door jamb; and said first and second strike plate portions each comprising a first plate element thereof above said second opening and a second plate element thereof below said second opening, each of said first and second plate elements comprising locating means thereon, wherein the first and second plate elements of said first strike plate portion each includes a first opening therein spaced from a front edge thereof for positioning at a front edge of said doorjamb, and wherein each of the first and second plate elements of said second strike plate portion comprises a substantially horizontal elongate opening therein for cooperating with said fastener passing said first opening in the first and second plate elements of said first strike plate portion, said elongate openings having a plurality of teeth positioned along at least one horizontal interior edge of said elongate opening, wherein said locating means comprises a gear projecting from the abutting surface of the first and second plate elements of said first strike plate portion towards the abutting surface of said second strike plate portion, said gear having at least one cog capable of engaging said teeth on said elongate opening, said teeth and said at least one cog defining engaging surfaces of said first and second strike plate portions thereby holding said second strike plate portion against movement in said adjustment direction.

### BRIEF DESCRIPTION OF THE DRAWINGS

FIG. 1 is an exploded perspective view of the elements of the adjustable door strike plate assembly according to the present invention.

FIG. 2 is an exploded perspective view of a portion of the adjustable door strike plate assembly according to the present invention.

FIG. 3 is an elevational side view of the adjustable door strike plate portion engaging with the fixed strike plate portion according to the present invention.

FIG. 4 is cross-sectional top view of the lines IV-IV of FIG. 3 of the present invention.

FIG. 5 is close up view of the locating means of the adjustable door strike plate assembly according to the present invention.

### DETAILED DESCRIPTION OF THE PREFERRED EMBODIMENT

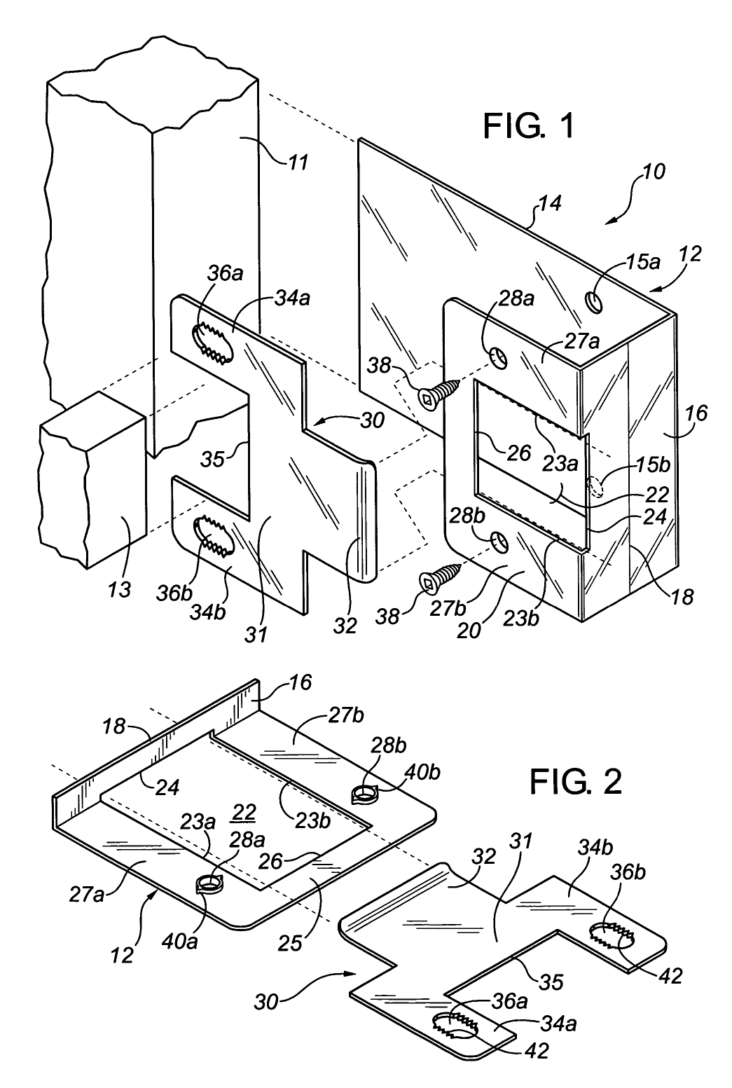

The present invention is an adjustable door strike assembly. Shown in FIG. 1 is strike assembly 10. Assembly 10 comprises a fixed plate portion 12 and removable plate portion 30. Fixed plate 12 is a U-shaped member adapted for sliding onto the edge of doorjamb 11.

Fixed plate 12 consists of back member 14, side edge 16 and front member 20. Front member 20 further comprises of top and bottom plate elements 27a and 27b, respectively, and vertical element 25 to form opening 22. Openings 28a and 28b are located on top and bottom plate elements 27a and 27b, respectively. Front edge 24 is suitably recessed into side edge 16 to accommodate the thickness of movable plate 30.

Side edge 16 further comprises a crease line 18 which is a vertical score line formed alongside edge 16 during the manufacture of fixed plate 12. Both fixed plate 12 and movable plate 30 are, preferably, made of sheet metal material suitable for door strike assemblies. Crease line 18 permits back member 14 to be separated from front member 20 by bending the members about crease line 18 until metal fatigue allows back member 14 to separate from front member 20. Removing back member 14 may be desirable when installing assembly 10 as a retrofit or renovation on an existing finished door frame. In new construction, back member 14 is slipped between doorjamb 11 and the door frame (not shown) prior to fastening assembly 10 to doorjamb 11.

Movable plate 30 consists of tongue 32 and top and bottom legs 34a and 34b all joined together by vertical element 31. Legs 34a and 34b have elongated horizontal openings 36a and 36b. Tongue 32 passes through opening 22 of fixed plate 12 such that movable plate 30 is sandwiched between fixed plate 12 and doorjamb 11 when assembly 10 is installed on doorjamb 11.

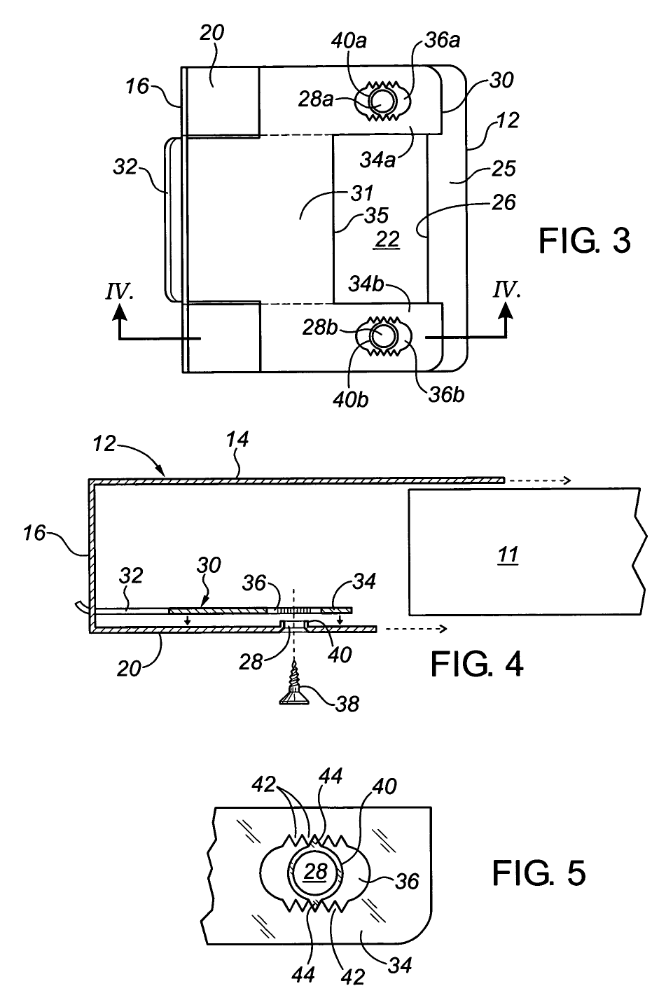

When movable plate 30 is fitted to fixed plate 12, edges 26, 35 and 23a and 23b form an opening for receiving bolt 13 of a door lock. Elongated openings 36a and 36b align with openings 28a and 28b. Screws 38 pass through openings 28 and 36 into doorjamb 11 to secure assembly 10 to doorjamb 11. If back member 14 is retained on fixed member 12, openings 15a and 15b are positioned on back member 14 to align with openings 28a and 28b such that screws 38 are long enough to pass through openings 28 and 15 into adjacent door frame may be used. Legs 34a and 34b abut to top and bottom plate elements 27a and 27b when movable plate 30 is installed between fixed plate 12 and doorjamb 11. Locating means situated between legs 34 and plate elements 27 are used to engage and secure the position of movable plate 30 relative to fixed plate 12. The locating means is illustrated in FIGS. 2 to 5. Projecting from the abutting surface of top and bottom plate elements 27a and 27b are gears 40a and 40b. Gears 40a and 40b surround openings 28a and 28b. Gears 40a and 40b also align with openings 36a and 36b on legs 34a and 34b of movable plate 30. Located on the upper and lower horizontal edges of openings 36a and 36b are teeth 42. Gears 40a and 40b have upper and lower cogs 44 that align with teeth 42 when movable plate 30 is installed with fixed plate 12. Gears 40 align with openings 36 such that cogs 44 will mesh with teeth 42. The position of movable plate 30 relative to fixed plate 12 is dependent on which of teeth 42 cogs 44 are meshed with. Preferably, teeth 42 are spaced 1/16″ apart whereby openings 36 have five teeth that will permit a horizontal adjustment of movable plate 30 relative to fixed plate 12 up to ¼″.

In operation, assembly 10 is slipped onto doorjamb 11 with movable strike plate fitted between front member 20 such that tongue 32 extends through opening 22. Screws 38 pass through opening 28a and 28b and through elongated openings 36a and 36b into jamb 11. On new installations where back member 14 is retained on fixed plate 12, screws 38 long enough to pass through openings 15a and 15b and into the adjoining door frame may be used. With screws 38 not fully tightened such that movable plate 30 is loose, its position can be adjusted horizontally relative to fixed plate 12 to provide the required closing position for bolt 13 of the door lock. Once this position has been located, screws 38 are then fully tightened thereby securing the position of movable plate 30 to fixed plate 12. Adjustment to assembly 10 can easily be carried out by listening screws 38 such that movable plate 30 can be moved relative to fixed plate 12 to the new required position whereby cogs 44 mesh with different teeth 42 in openings 36. Upon locating this new position, screws 38 are then tightened to secure the position of assembly 10.

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized at the scope of the invention as defined and limited only by the claims that follow.

We claim:

1. An adjustable strike plate assembly for attachment to a door jamb to engage a bolt of a door lock, comprising:
a) a first strike plate assembly portion having at least one first opening therein for receiving a fastener therethrough for fastening said first strike plate portion to said door jamb, and having a second opening for receiving said bolt;
b) a second strike plate portion adapted for mounting between said first strike plate portion and said door jamb wherein said second strike portion comprises an abutting surface for contacting with an abutting surface of said first strike plate portion, said second strike plate portion further comprising a plate element thereof extending substantially vertical across said second opening thereby defining a vertical side edge of said second opening for engaging a vertical side of said bolt to hold said door in a closed position, said second strike plate portion further capable of movement relative to said first strike plate portion in an adjustment direction substantially perpendicular to said vertical side edge so as to vary the position the position of said vertical side edge relative to said doorjamb; and
c) said first and second strike plate portions each comprising a first plate element thereof above said second opening and a second plate element thereof below said second opening, each of said first and second plate elements comprising locating means thereon, wherein the first and second plate elements of said first strike plate portion each includes a first opening therein spaced from a front edge thereof for positioning at a front edge of said door jamb, and wherein each of the first and second plate elements of said second strike plate portion comprises a substantially horizontal elongate opening therein for cooperating with said fastener passing said first opening in the first and second plate elements of said first strike plate portion, said elongate openings having a plurality of teeth positioned along at least one horizontal interior edge of said elongate opening, wherein said locating means comprises a gear projecting from the abutting surface of the first and second plate elements of said first strike plate portion towards the abutting surface of said second strike plate portion, said gear having at least one cog capable of engaging said teeth on said elongate opening, said teeth and said at least one cog defining engaging surfaces of said first and second strike plate portions thereby holding said second strike plate portion against movement in said adjustment direction.

2. The adjustable strike plate assembly as set forth in claim 1 wherein said elongate openings comprise teeth along the upper and lower horizontal interior edges of said elongate openings and wherein said gears comprise upper and lower cogs for engaging the teeth along the upper and lower horizontal interior edges of said elongate openings.
